(19) United States
(12) Patent Application Publication
(10) Pub. No.: US 2026/0077693 A1
(43) Pub. Date: Mar. 19, 2026

(54) HEADREST

(71) Applicant: TS TECH CO., LTD., Asaka-shi, Saitama (JP)

(72) Inventors: Nobuyuki TEZUKA, Tochigi (JP); Kazuki KOBAYASHI, Tochigi (JP)

(21) Appl. No.: 19/106,848

(22) PCT Filed: Sep. 27, 2023
(86) PCT No.: PCT/JP2023/035084

§ 371 Date: Feb. 26, 2025

Related U.S. Application Data
(60) Provisional application No. 63/425,755, filed on Nov. 16, 2022.
(60) Provisional application No. 63/483,028, filed on Feb. 3, 2023.

(30) Foreign Application Priority Data
Sep. 19, 2023 (JP) 2023-150699

(51) Int. Cl. B60N 2/879; B60N 2/818

(52) U.S. Cl. CPC B60N 2/879; B60N 2/818

(57) ABSTRACT

Provided is a headrest provided with speakers and configured to prevent deformation of the speakers and a connecting member.

The headrest for a vehicle seat includes a headrest frame supported by a seat back, electrical components supported by the headrest frame, and a connecting member extending horizontally to connect the electrical components. The headrest frame includes headrest stays supported by the seat back and extending vertically, vertical frames attached to the headrest stays, and a horizontal frame extending horizontally to connect upper ends of the vertical frames. Upper parts of the vertical frames extend obliquely upward toward the front. The electrical components are provided at lateral positions outside of the vertical frames with lower parts thereof supported by lower parts of the vertical frames, and the connecting member is located rearward of the horizontal frame.

### TECHNICAL FIELD

The present invention relates to a headrest.

### BACKGROUND ART

Patent Document 1 discloses a headrest for a vehicle seat provided with speakers therein. The headrest includes a headrest frame, a pair of speakers attached to the headrest frame, and a headrest cushion member that covers the headrest frame and the speakers. The left and right speaker units are connected to each other via a connecting member. Openings are formed at locations in front of the speaker units in the headrest cushion member.

### PRIOR ART DOCUMENT(S)

### Patent Document(s)

Patent Document 1: JP2017-525456A

### SUMMARY OF THE INVENTION

### Task to be Accomplished by the Invention

In the headrest disclosed in Patent Document 1, the speakers and the connecting member are arranged frontward of the headrest frame. This arrangement results in that the speakers and the connecting member can be deformed by the application of a load from the front.

The present invention has been made in view of the problem of the prior art, and a primary object of the present invention is to provide a headrest provided with speakers which is configured to reduce deformation of the speakers and a connecting member.

### Means to Accomplish the Task

As a solution to the above-described tasks to be accomplished, an aspect of the present invention provides a headrest (4) for a vehicle seat (1), the headrest comprising: a headrest frame (5) supported by a seat back; a pair of left and right electrical components (6) supported by the headrest frame; and a connecting member (10) extending in a left-right direction and configured to connect the left and right electrical components, wherein the headrest frame comprises: a pair of left and right headrest stays (12) that are supported by the seat back, and extend in a vertical direction, a pair of left and right vertical frames (13A) that extend in the vertical direction and are attached to the corresponding headrest stays, and a horizontal frame (13B) that extends in a left-right direction and connects upper ends of the vertical frames, wherein upper parts of the vertical frames extend obliquely upward toward the front, wherein the electrical components are arranged outside of the vertical frames in the left-right direction, wherein lower parts of the electrical components are supported by lower part of the vertical frames, and wherein the connecting member is located rearward of the horizontal frame.

The configuration, in which the left and right components are connected by the connecting member and thus are supported by the headrest frame, determines the relative positions of the left and right components. As the left and right electrical components are provided at lateral positions outside of the vertical frames, and the connecting member is located rearward of the horizontal frame, which prevents the application of a load to the electrical components from the front, thereby reducing deformation of the speakers and the connecting member. In other words, this configuration reduces a change in the relative positions of the left and right electrical components.

The vehicle seat may be further configured such that the vertical frames are provided with first brackets (21) that extend outward in the left-right direction, and wherein the electrical components are secured to the corresponding first brackets.

In this configuration, the left and right casings are placed at lateral positions outside of the vertical frames. As a result, when the electrical components are speakers, the electrical components can output sound toward a seated occupant.

The vehicle seat may be further configured such that the connecting member comprises: a connecting member body (51) with a front-facing surface and a rear-facing surface, a first reinforcing part (52) that extends rearward from the upper end of the connecting member body, and a plurality of second reinforcing parts (53) that protrude rearward from the rear-facing surface of the connecting member body and are connected to the first reinforcing part.

In this configuration, the first reinforcing part prevents the deformation of the connecting member caused due to a load from the rear. The second reinforcing parts prevent the deformation of the connecting member caused due to a load from the above.

The vehicle seat may be further configured such that the connecting member further comprises a protruding tab (55) that protrudes downward from the connecting member body and a tab hole (56) formed above the protruding tab, wherein each of the electrical components includes a speaker unit (31), a first harness (33) with a first end connected to the speaker unit, and a female connector (34) connected to a second end of the first harness, wherein the first end of the first harness is located rearward of the connecting member body of the connecting member, and wherein the female connector is secured to a front surface of the protruding tab.

This configuration reduces interference between the female connectors and other components, facilitating the assembly of the electrical components to the headrest frame.

The vehicle seat may be further configured such that each of the electrical components includes a male connector (64) fitted into the female connector, and a second harness (66) connected to the male harness, wherein each of the headrest stays has a tubular shape, wherein a front part of the upper end of each of the headrest stays is coupled to a rear part of the lower end of the corresponding vertical frame, and wherein each of the second harnesses extends through a hole inside the corresponding headrest stay.

This configuration, in which the left and right headrest stays are positioned rearward of the corresponding vertical frames, allows a load from the front to be applied to the vertical frames, which reduces the contact between an edge defining the upper opening of each of the headrest slays and a corresponding one of the second harnesses.

The vehicle seat may be further configured such that the headrest further comprises a headrest cover (8) that covers the electrical components, the vertical frames, and the horizontal frame, wherein the headrest cover includes a front cover (8A) that covers the electrical components, the vertical frames and the horizontal frame from the front, and a rear cover (8B) that engages the front cover and covers the electrical components, the vertical frames and the horizontal frame from the rear, and wherein the second harnesses are secured to harness catchers (121) provided on the rear cover.

This configuration, in which a load to the headrest 4 is applied to the headrest cover, effectively reduces the deformation of the speakers and the connecting member. This configuration also reduces the movement of the second harnesses.

The vehicle seat may be further configured such that the left and right first brackets each have at least one first through hole (22B) formed therein, wherein the front cover has front side first fastening holes (83) that are aligned to the first through holes, wherein the rear cover has rear side first fastening holes (102) that are aligned to the first through holes and the front side first fastening holes, wherein each of the rear side first fastening holes is threaded to form a female screw, and wherein the front cover and the rear cover are fastened with first bolts (118A) that extend through the first through holes and the front side first fastening holes, and are screwed to the female screws formed in the rear side first fastening holes.

This configuration, in which the front and rear covers are fastened to the vertical frames via the first brackets, allows the headrest cover to be stably supported by the headrest frame.

The vehicle seat may be further configured such that the horizontal frame includes a second bracket (24) provided at a location that is aligned to the tab hole, wherein the second bracket has a second through hole (26) formed therein, wherein the front cover has a front side second fastening hole (84) that is aligned to the second through hole, wherein the rear cover has a rear side second fastening hole (104) that is aligned to the second through hole and the front side second fastening hole, wherein the rear side second fastening hole is threaded to form a female screw, and wherein the front cover and the rear cover are fastened with a second bolt (118B) that extends through the second through hole and the front side second fastening hole and that is screwed to the female screw formed in the rear side second fastening holes.

This configuration, in which the front and rear covers are fastened to the horizontal frame via the second bracket, allows the headrest cover to be more stably supported by the headrest frame.

The vehicle seat may be further configured such that the front cover has front cover protrusions (81C) that protrude rearward from the front cover and that overlap the headrest frame as viewed from the front.

In this configuration, loads applied to the front cover from the front are transmitted to the frame.

The vehicle seat may be further configured such that the protruding tab of the connecting member body has a positioning hole (59) extending therethrough in the front-rear direction, and wherein the rear cover has a positioning protrusion (112) that engages the positioning hole.

This configuration determines the relative positions of the left and right components when the electrical components are attached to the rear cover.

### Effect of the Invention

As a solution to the above-described tasks to be accomplished, the present invention can be embodied as a headrest (4) for a vehicle seat (1), the headrest comprising: a headrest frame (5) supported by a seat back; a pair of left and right electrical components (6) supported by the headrest frame; and a connecting member (10) extending in a left-right direction and configured to connect the left and right electrical components, wherein the headrest frame comprises: a pair of left and right headrest stays (12) that are supported by the seat back, and extend in a vertical direction, a pair of left and right vertical frames (13A) that extend in the vertical direction and are attached to the corresponding headrest stays, and a horizontal frame (13B) that extends in a left-right direction and connects upper ends of the vertical frames, wherein upper parts of the vertical frames extend obliquely upward toward the front, wherein the electrical components are arranged outside of the vertical frames in the left-right direction, wherein lower parts of the electrical components are supported by lower part of the vertical frames, and wherein the connecting member is located rearward of the horizontal frame.

The configuration, in which the left and right components are connected by the connecting member and thus are supported by the headrest frame, determines the relative positions of the left and right components. As the left and right electrical components are provided at lateral positions outside of the vertical frames, and the connecting member is located rearward of the horizontal frame, which prevents the application of a load to the electrical components from the front, thereby reducing deformation of the speakers and the connecting member. In other words, this configuration reduces a change in the relative positions of the left and right electrical components.

The vehicle seat may be further configured such that the vertical frames are provided with first brackets (21) that extend outward in the left-right direction, and wherein the electrical components are secured to the corresponding first brackets.

In this configuration, the left and right casings are placed at lateral positions outside of the vertical frames. As a result, when the electrical components are speakers, the electrical components can output sound toward a seated occupant.

The vehicle seat may be further configured such that the connecting member comprises: a connecting member body (51) with a front-facing surface and a rear-facing surface, a first reinforcing part (52) that extends rearward from the upper end of the connecting member body, and a plurality of second reinforcing parts (53) that protrude rearward from the rear-facing surface of the connecting member body and are connected to the first reinforcing part.

In this configuration, the first reinforcing part prevents the deformation of the connecting member caused due to a load from the rear. The second reinforcing parts prevent the deformation of the connecting member caused due to a load from the above.

The vehicle seat may be further configured such that the connecting member further comprises a protruding tab (55) that protrudes downward from the connecting member body and a tab hole (56) formed above the protruding tab, wherein each of the electrical components includes a speaker unit (31), a first harness (33) with a first end connected to the speaker unit, and a female connector (34) connected to a second end of the first harness, wherein the first end of the first harness is located rearward of the connecting member body of the connecting member, and wherein the female connector is secured to a front surface of the protruding tab.

This configuration reduces interference between the female connectors and other components, facilitating the assembly of the electrical components to the headrest frame.

The vehicle seat may be further configured such that each of the electrical components includes a male connector (64) fitted into the female connector, and a second harness (66) connected to the male hamess, wherein each of the headrest stays has a tubular shape, wherein a front part of the upper end of each of the headrest stays is coupled to a rear part of the lower end of the corresponding vertical frame, and wherein each of the second harnesses extends through a hole inside the corresponding headrest stay.

This configuration, in which the left and right headrest stays are positioned rearward of the corresponding vertical frames, allows a load from the front to be applied to the vertical frames, which reduces the contact between an edge defining the upper opening of each of the headrest slays and a corresponding one of the second harnesses.

The vehicle seat may be further configured such that the headrest further comprises a headrest cover (8) that covers the electrical components, the vertical frames, and the horizontal frame, wherein the headrest cover includes a front cover (8A) that covers the electrical components, the vertical frames and the horizontal frame from the front and a rear cover (8B) that engages the front cover and covers the electrical components, the vertical frames and the horizontal frame from the rear, and wherein the second harnesses are secured to harness catchers (121) provided on the rear cover.

This configuration, in which a load to the headrest 4 is applied to the headrest cover, effectively reduces the deformation of the speakers and the connecting member. This configuration also reduces the movement of the second harnesses.

The vehicle seat may be further configured such that the left and right first brackets each have at least one first through hole (22B) formed therein, wherein the front cover bas front side first fastening holes (83) that are aligned to the first through holes, wherein the rear cover has rear side first fastening holes (102) that are aligned to the first through holes and the front side first fastening holes, wherein each of the rear side first fastening holes is threaded to form a female screw, and wherein the front cover and the rear cover are fastened with first bolts (118A) that extend through the first through holes and the front side first fastening holes, and are screwed to the female screws formed in the rear side first fastening holes.

This configuration, in which the front and rear covers are fastened to the vertical frames via the first brackets, allows the headrest cover to be stably supported by the headrest frame.

The vehicle seat may be further configured such that the horizontal frame includes a second bracket (24) provided at a location that is aligned to the tab hole, wherein the second bracket has a second through hole (26) formed therein, wherein the front cover has a front side second fastening hole (84) that is aligned to the second through hole, wherein the rear cover has a rear side second fastening hole (104) that is aligned to the second through hole and the front side second fastening hole, wherein the rear side second fastening hole is threaded to form a female screw, and wherein the front cover and the rear cover are fastened with a second bolt (118B) that extends through the second through hole and the front side second fastening hole and that is screwed to the female screw formed in the rear side second fastening holes.

This configuration, in which the front and rear covers are fastened to the horizontal frame via the second bracket, allows the headrest cover to be more stably supported by the headrest frame.

The vehicle seat may be further configured such that the front cover has front cover protrusions (81C) that protrude rearward from the front cover and that overlap the headrest frame as viewed from the front.

In this configuration, loads applied to the front cover from the front are transmitted to the frame.

The vehicle seat may be further configured such that the protruding tab of the connecting member body has a positioning hole (59) extending therethrough in the front-rear direction, and wherein the rear cover has a positioning protrusion (112) that engages the positioning hole.

This configuration determines the relative positions of the left and right components when the electrical components are attached to the rear cover.

### BRIEF DESCRIPTION OF THE DRAWINGS

FIG. 1 is a perspective view of a seat provided with a headrest according to one embodiment of the present invention;

FIG. 2 is a front view of the headrest of the embodiment of FIG. 1;

FIG. 3 is an exploded perspective view of the headrest;

FIG. 4 is a front view showing the headrest with the front cover removed;

FIG. 5 is a rear view of the headrest with the headrest cover removed;

FIG. 6 is a cross-sectional plan view of the headrest;

FIG. 7 is a cross-sectional plan view of the headrest;

FIG. 8 is a perspective view showing the rear side of the front cover;

FIG. 9 is a perspective view showing the front side of the rear cover;

FIG. 10 is a cross-sectional plan view of the left side of the headrest;

FIG. 11 is a front view of an important part of the headrest;

FIG. 12 is a front view showing one of the headrest stays and a protection member; and

FIG. 13 includes (A) and (B), where (A) is a cross-sectional side view showing the protection member viewed from the side, and (B) is a plan view showing the protection member viewed from the above.

### DESCRIPTION OF THE PREFERRED EMBODIMENT(S)

Embodiments of a headrest according to the present invention will be described with reference to the appended drawings, in which the headrest is used in a seat of an automobile. In the following description, the front/rear, left/right (lateral), and up/down (vertical) directions are defined relative to a vehicle equipped with the vehicle seat.

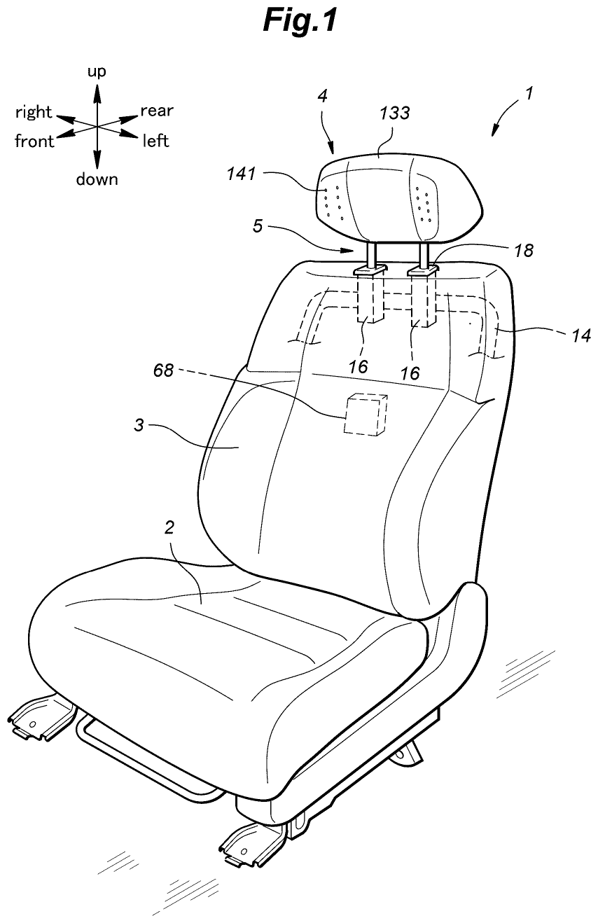

As shown in FIG. 1, a seat 1 includes a seat cushion 2, a seat back 3, and a headrest 4. The seat cushion 2 supports the buttocks of an occupant from below. The seat back 3 extends upward from the rear of the seat cushion 2. The seat back 3 supports the occupant's back from behind. The headrest 4 is provided at the upper end of the seat back 3. The headrest 4 supports the occupant's head from behind.

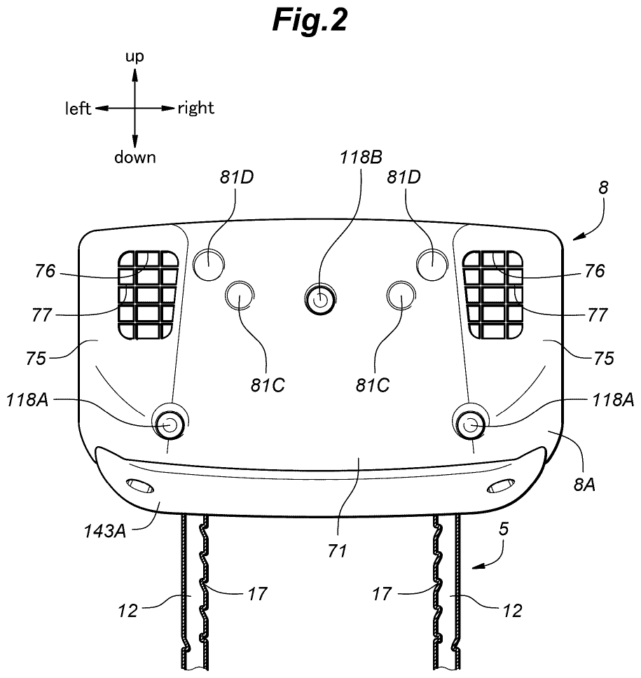

As shown in FIGS. 2 to 4, the headrest 4 includes a headrest frame 5 that serves as a structural frame of the headrest 4, a pair of left and right electrical components 6 supported by the headrest frame 5, and a headrest cover 8 that covers the electrical components 6 and the headrest frame 5. Examples of the electrical component 6 include a speaker and a microphone. In the present embodiment, the electrical components 6 are speakers and microphones. The left and right electrical components 6 are connected to each other by a connecting member 10.

As shown in FIGS. 2 to 5, the headrest frame 5 includes a pair of headrest stays 12 extending in the vertical direction, a pair of vertical frames 13A that are connected to the corresponding headrest stays 12, and a horizontal frame 13B that connects the upper ends of the vertical frames 13A.

Each of the headrest stays 12 has a tubular shape. As shown in FIG. 1, the left and right headrest stays 12 are supported by a seat back frame 14 that serves as a structural frame of the seat back 3. The seat back frame 14 has left and right stay supports 16 that receive the headrest stays 12. Each of the stay supports 16 has a hollow cylindrical shape with open ends at both ends. The stay supports 16 are preferably formed of a plastics material. The headrest stays 12 are inserted into the corresponding stay supports 16. The lower end of each headrest stay 12 protrudes from the lower end of the corresponding stay support 16. As shown in FIG. 2, each of the headrest stays 12 has an outer surface on which a plurality of engagement grooves 17 are formed in a row at intervals along its length direction. As shown in FIG. 1, each of the stay supports 16 is provided with a lock device 18 which is selectively engaged with one of the plurality of engagement grooves 17. The engagement of the lock device 18 with one of the plurality engagement grooves 17 determines the height of the headrest 4 relative to the seat back 3.

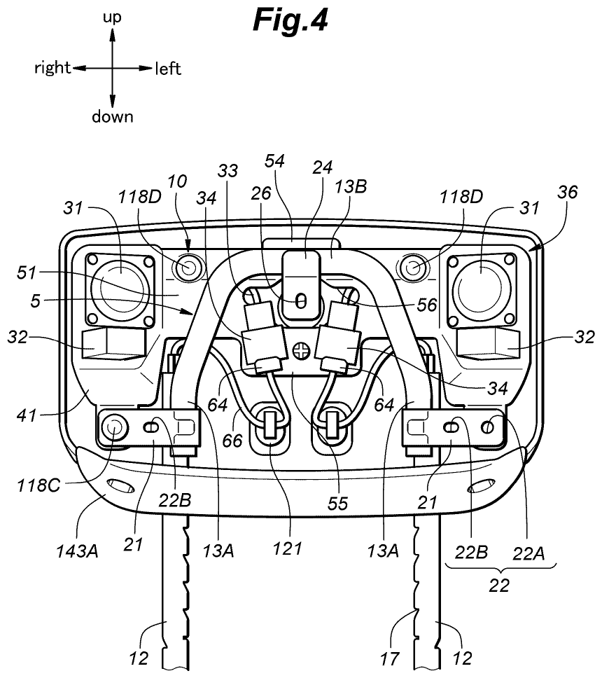

As shown in FIGS. 4, 5 and 7, each of the vertical frames 13A is positioned frontward of the corresponding headrest stay 12. Each of the vertical frames 13A has a lower part that extends in the vertical direction. The rear part of the lower part of each vertical frame 13A is coupled to a front part of the upper end of the corresponding headrest stay 12. The lower rear part of each vertical frame 13A may be joined to the upper end front part of the corresponding headrest stay 12, for example by welding. Each of the vertical frames 13A has an upper part that extends obliquely upward toward the front. More specifically, the upper part of each vertical frame 13A is inclined toward the upper front and laterally inward. The horizontal frame 13B extends in the left-right direction and connects the upper ends of the left and right vertical frames 13A. In other words, the horizontal frame 13B is positioned frontward of the lower ends of the left and right vertical frames 13A. The left and right vertical frames 13A and the horizontal frame 13B may be formed by the bending of a single pipe material.

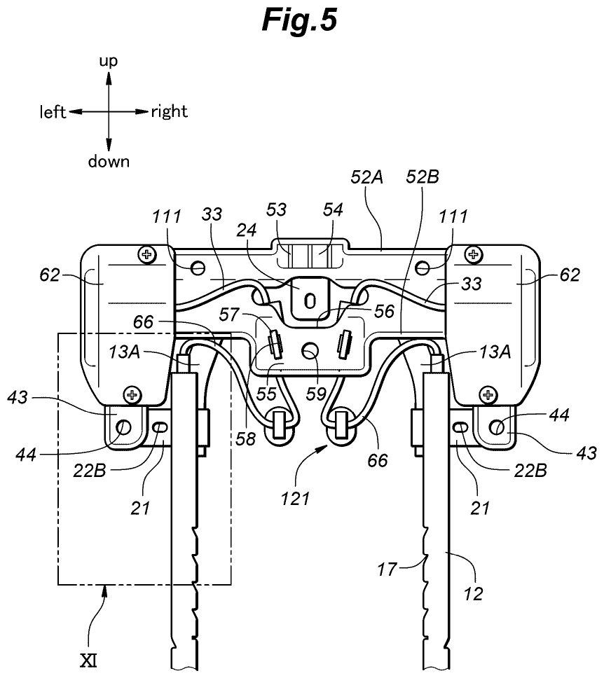

As shown in FIGS. 4 and 5, the vertical frames 13A have first brackets 21 to which the corresponding electrical components 6 are secured. Each of the first brackets 21 extends laterally outward from the lower part of the corresponding vertical frame 13A. Each of the first brackets 21 has a plate shape with front-facing and rear-facing surfaces. Each of the first brackets 21 has a frame-side base end that is joined to the lower front part of the corresponding vertical frame 13A, for example, by welding. Each of the first brackets 21 has a plurality of first through holes 22 that extend therethrough in the thickness direction. In the present embodiment, each of the first brackets 21 has an outer first through hole 22A and an inner first through hole 22B at the outer tip and the lateral center thereof, respectively.

The horizontal frame 13B is provided with a second bracket 24 for supporting the headrest cover 8. The second bracket 24 extends downward from the center of the horizontal frame 13B. The second bracket 24 has a plate shape with front-facing and rear-facing surfaces. The upper end of the second bracket 24 is joined to the front of the horizontal frame 13B, for example, by welding. The second bracket 24 has a second through hole 26 that extends therethrough in the thickness direction.

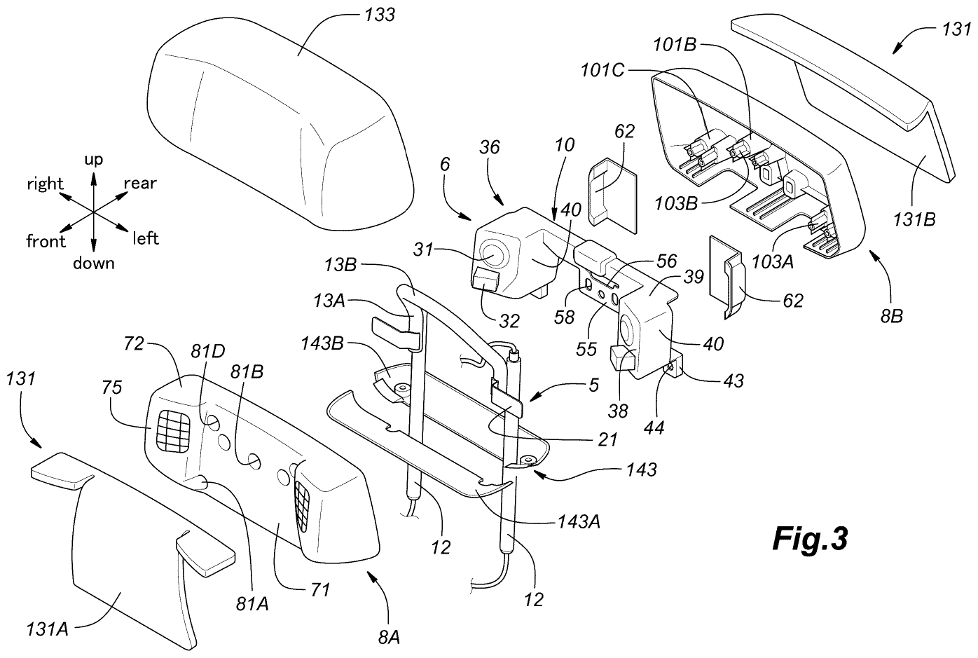

As shown in FIGS. 3 and 4, the left and right electrical components 6 are located outward of the corresponding vertical frames 13A. Each of the electrical components 6 has a speaker unit 31, a microphone unit 32, a first harness 33 connected to the speaker unit 31 and the microphone unit 32 at one end (first end), and a female connector 34 connected to the other end (second end) of the first harness 33. The speaker unit 31 is an audio output unit with a speaker, and the microphone unit 32 is an audio input unit with a microphone. Each of the first harnesses 33 generally extends in the left-right direction. Each of the female connectors 34 is connected to the laterally inner end of the corresponding first harness 33. The laterally outer end of each of the first harnesses 33 branches off into two or more connector ends, which are connected to the corresponding speaker unit 31 and microphone unit 32.

As shown in FIGS. 3 to 6, each of the electrical components 6 is supported by the corresponding vertical frame 13A and has a casing 36 that houses the corresponding speaker unit 31 and microphone unit 32. Each of the casings 36 has a lower part that is supported by the lower part of the vertical frame 13A. The casing 36 has a box shape that opens toward the rear. The casing 36 has a front wall 38 with a front-facing surface, an upper wall 39 extending rearward from the upper edge of the front wall 38, left and right side walls 40 extending rearward from the left and right side edges of the front wall 38, and a lower wall 41 extending rearward from the lower edge of the front wall 38. The left and right inner side walls 40 of each casing 36 are positioned laterally outward of the corresponding vertical frames 13A. The speaker unit 31 and microphone unit 32 are arranged within a space defined by the respective walls 38, 39, 40, and 41. The casing 36 may be formed of plastics material.

As shown in FIGS. 3 to 5 and 10, each of the lower walls 41 is provided with a flap 43 protruding downward therefrom the lower wall 41. The flap 43 has a plate shape with front-facing and rear-facing surfaces. The flap 43 has a through hole 44 extending therethrough in the thickness direction. The flap 43 is located rearward of an outer side tip of the corresponding first bracket 21. More specifically, each of the through holes 44 formed in the flap 43 is positioned to overlap the outer first through hole 22A formed in the corresponding first bracket 21 in the front-rear direction. Each of the casings 36 is attached to the headrest frame 5 and the headrest cover 8 by a bolt (third bolt 118C described later) extending through the outer first through hole 22A of the first bracket 21 and the through hole 44 of the flap 43.

As shown in FIGS. 3 to 6, the front wall 38 of each casing 36 preferably faces obliquely inward toward the front. In the present embodiment, the front wall 38 has two holes (not shown) extending therethrough in the thickness direction. The positions of the holes in the front wall 38 are vertically aligned to each other. The speaker unit 31 and the microphone unit 32 are exposed through the corresponding holes. Specifically, the speaker unit 31 is exposed through the upper hole, and the microphone unit 32 is exposed through the lower hole. As each of the left and right casings 36 is positioned laterally outward of the corresponding vertical frame 13A, the corresponding speaker unit 31 outputs sound towards an occupant; that is, outputs sound toward the front inner direction. The corresponding microphone unit 32 collects sound from the front inner side.

As shown in FIGS. 3 to 5, the connecting member 10 is located rearward of the horizontal frame 13B. The connecting member 10 includes a connecting member body 51 having front-facing and rear-facing surface, an upper first reinforcing part 52A that extends rearward from the upper end of the connecting member body 51, and a plurality of second reinforcing parts 53 that protrude rearward from the rear-facing surface of the connecting member body 51 and are connected to the upper first reinforcing part 52A. The connecting member 10 may further include a lower first reinforcing part 52B that extends rearward from the lower end of the connecting member body 51. In the present embodiment, the connecting member 10 and the left and right casings 36 are integrally formed into a single piece. The connecting member 10 may be formed of the plastics material as the casings 36.

The connecting member body 51 extends in the left-right direction. The connecting member body 51 has a plate shape with front-facing and rear-facing surfaces. In the present embodiment, the front of the upper part of the connecting member body 51 faces frontward, while the front of the lower part of the connecting member body 51 faces obliquely downward toward the front. The upper part of the connecting member body 51 is positioned rearward of the horizontal frame 13B.

The upper first reinforcing part 52A and lower first reinforcing part 52B extend in the left-right direction. The upper first reinforcing part 52A and lower first reinforcing part 52B each are formed into a plate shape with the up-facing and down-facing surfaces. Each of the upper first reinforcing part 52A and lower first reinforcing part 52B reduces the deformation of the connecting member 10 by the application of a load from the rear.

A first bulging part 54 bulges frontward from the center of the upper part of the connecting member body 51. In the present embodiment, the first bulging part 54 has a rectangular parallelepiped shape. The first bulging part 54 may have an upper part located above the upper part of the connecting member body 51 of the connecting member 10. In other words, the upper first reinforcing part 52A partially defines the upper part of the first bulging part 54.

Each of a plurality of second reinforcing parts 53 extends from the rear of a bottom part of the first bulging part 54. Each of the second reinforcing parts 53 has a plate shape with left-facing and right-facing surfaces. The upper end of each second reinforcing part 53 is joined to the lower surface of the upper first reinforcing part 52A, which defines the upper part of the first bulging part 54. The lower end of each second reinforcing part 53 is joined to the upper surface of the connecting member body 51, which defines the lower part of the first bulging part 54. The second reinforcing parts 53 reduce the deformation of the connecting member 10 by the application of a load from the above.

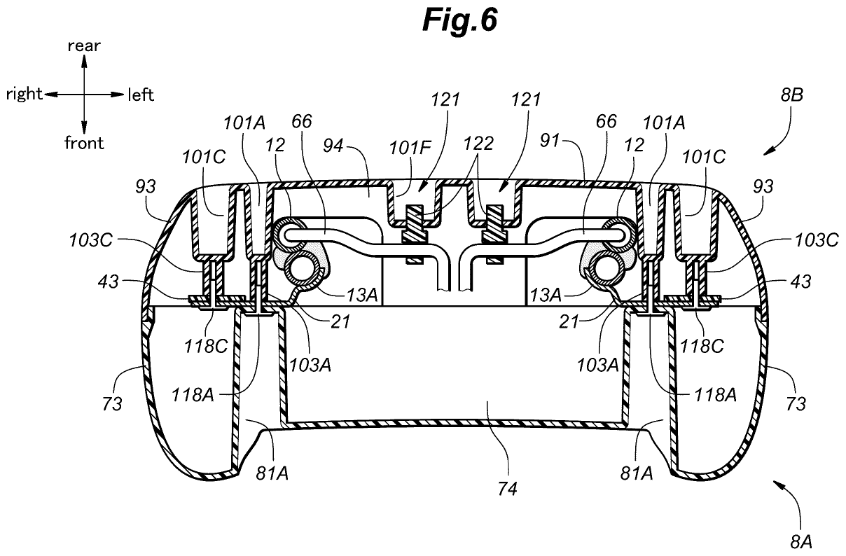

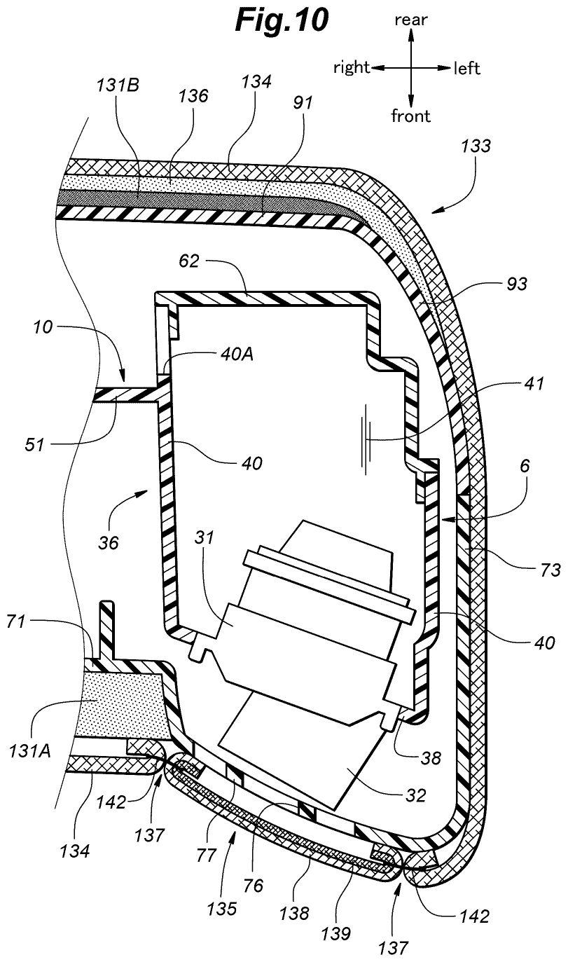

Left and right edges of the connecting member body 51, the upper first reinforcing part 52A, and the lower first reinforcing part 52B are joined to the corresponding inner side walls 40 of the left and right casings 36, respectively. Each of the side walls 40, to which the connecting member 10 is joined, preferably has a cutout 40A (FIGS. 6 and 10) that extends therethrough in the left-right direction. The cutout 40A is preferably positioned rearward of the connecting member body 51 of the connecting member 10 and between the upper and lower first reinforcing parts 52A and 52B.

Furthermore, the connecting member 10 has a protruding tab 55 protruding downward from the connecting member body 51 and a tab hole 56 formed above the protruding tab 55. The protruding tab 55 is formed as a plate with front-facing and rear-facing surfaces. The protruding tab 55 protrudes downward from the center of the lower part of the connecting member body 51. The left and right female connectors 34 are secured to the front of the protruding tab 55. As shown in FIG. 6, for example, each of the female connectors 34 may have a latching pawl 57, which can engage with a latching hole 58 formed in the protruding tab 55, thereby securing the corresponding female connector 34 to the front of the protruding tab 55. In addition, the protruding tab 55 has a positioning hole 59 extending therethrough in the front-rear direction. The positioning hole 59 engages with a positioning protrusion 112 formed on a rear cover 8B described later.

The tab hole 56 is formed in an upper part in the lower part of the connecting member body 51. The tab hole 56 extends therethrough the lower part of the connecting member body 51 in the thickness direction. The tab hole 56 partially overlaps the second bracket 24 on the horizontal frame 13B.

As shown in FIGS. 3 and 5, each of the electrical components 6 may have a lid 62 that covers the rear of the casing 36. Each of the lid 62 is formed in the shape of a plate with front-facing and rear-facing surfaces. Each of the lid 62 is preferably coupled to the rear edges of the upper wall 39 and the lower wall 41 of the corresponding casing 36. For example, the casing 36 may have a plurality of fastening plates each of which has front-facing and rear-facing surface and is fastened to the lid 62. Some of the plurality of fastening plates may extend downward from the rear edge of the upper wall 39. The remaining fastening plates may extend upward from the rear edge of the lower wall 41. Each fastening plate may have a fastening hole extending therethrough in the thickness direction. Each fastening hole may be threaded to have a female screw. The lid 62 may have a plurality of through holes that extends therethrough and overlap the corresponding fastening holes. The lid 62 may be attached to the connecting member 10 and the corresponding casing 36 by bolts that are passed through the through holes and screwed into the fastening holes. The lid 62 covers the corresponding casing 36 from the rear, thereby reducing sound leakage to the rear.

As shown in FIGS. 4 to 6, one end of each first harness 33 is located behind the connecting member body 51 of the connecting member 10. Each of the female connectors 34 is secured to the front of the protruding tab 55. Specifically, the inner end of each of the first harnesses 33, to which the female connectors 34 are to be connected, is pulled inward through the cutout 40A in the inner side wall 40 of the corresponding casing 36, and further pulled through the tab hole 56 of the connecting member 10 from the rear to the front. In other words, the outer ends of each of the first harnesses 33 connected to the speaker unit 31 and the microphone unit 32 are positioned rearward of the connecting member body 51 of the connecting member 10. The female connector 34 may be connected to the inner end of each of the first harnesses 33.

As shown in FIGS. 4 and 5, the left and right electrical components 6 further comprise male connectors 64 that can be fitted to the corresponding female connectors 34, and second harnesses 66 connected to the corresponding male connectors 64. Each second harness 66 extends in the vertical direction. Each of the male connectors 64 is connected to the upper end of the corresponding second harness 66. Each of the second harnesses 66 extends through a hole inside the corresponding one of the left and right headrest stays 12. Specifically, the upper end of each second harness 66 is pulled out through the inner hole of the corresponding headrest stay 12. The left and right headrest stays 12 are arranged rearward of the corresponding vertical frames 13A, which allows a load from the front to be applied to the vertical frame 13A. This reduces the contact between the second harness 66 and the edge that defines the upper end opening of the headrest stay 12.

The headrest further includes a control device 68 that is connected to the speaker units 31 and the microphone units 32 via the first harnesses 33, female connectors 34, male connectors 64 and second harnesses 66. In other words, the lower end of each of the second harnesses 66 is connected to the control device 68 (FIG. 1). The control device 68 is an electronic control device, which is a computing device having a microprocessor (MPU), a non-volatile memory, a volatile memory, and an interface. The control device 68 implements various applications by having the microprocessor execute programs stored in the nonvolatile memory. The control device 68 is preferably located within the seat back 3, below the seat cushion 2, or at any other proper location.

As shown in FIGS. 2 and 3, the headrest cover 8 includes a front cover 8A which covers the electrical components 6, vertical frames 13A, and horizontal frame 13B from the front, and a rear cover 8B which is engaged with the front cover 8A and covers the electrical components 6, vertical frames 13A, and horizontal frame 13B from the rear. The headrest cover 8 may be formed of a plastics material.

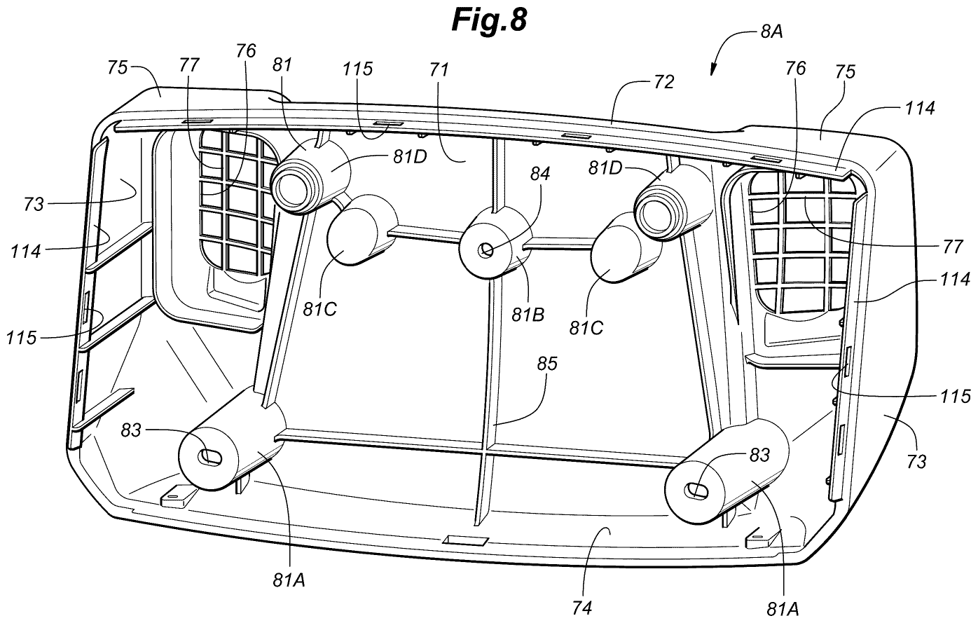

As shown in FIG. 8, the front cover 8A has a box shape with an opening facing rearward. The front cover 8A includes a front cover front wall 71 with front-facing and rear-facing surfaces, a front cover upper wall 72 extending rearward from the upper edge of the front cover front wall 71, left and right front cover side walls 73 extending rearward from the left and right side edges of the front cover front wall 71, and a front cover lower wall 74 extending rearward from the lower edge of the front cover front wall 71.

The front cover front wall 71 has a plurality of second bulging parts 75 that bulge frontward. In the present embodiment, the front cover front wall 71 includes two second bulging parts 75 on the left and right edges thereof. The bottom of each second bulging part 75 faces the front wall 38 of the corresponding casing 36. In other words, the respective front sides of the left and right second bulging parts 75 face frontward and laterally inward. The bottom of each second bulging part 75, which faces the speaker unit 31, has a cover opening 76 extending therethrough in the thickness direction. Each of the left and right cover openings 76 is provided with a lattice 77.

The front cover front wall 71 has a plurality of front side bosses 81 protruding rearward from the front part of the front cover front wall 71. Each of the front side bosses 81 may be formed as a bottomed hollow cylindrical shape that opens frontward. In the present embodiment, the front side bosses 81 comprise a plurality of first front side bosses 81A that face the first brackets 21 on the vertical frames 13A, and a second front side boss 81B that faces the second bracket 24 on the horizontal frame 13B. The bottom (facing rearward) of each of the first front side bosses 81A may be in contact with the center of the corresponding first bracket 21.

The front cover 8A has a plurality of front side first fastening holes 83 at positions aligned with the first through holes 22 of the first brackets 21. Each of the front side first fastening holes 83 extends through the front cover. Specifically, each of the front side first fastening holes 83 is formed at the bottom of the corresponding first front side boss 81A. Each of the front side first fastening holes 83 is positioned to be aligned with the inner first through hole 22B of the corresponding first bracket 21. In addition, the front cover 8A has a front side second fastening hole 84 positioned to be aligned with the second through hole 26 of the second bracket 24. The front side second fastening hole 84 extends through the front cover in the front-rear direction. The front side second fastening hole 84 is formed at the bottom (facing rearward) of the second front side boss 81B.

The front cover 8A has a plurality of protrusions that are positioned to overlap the headrest frame 5, as viewed from the front. Specifically, the front side bosses 81 further has a pair of third front side bosses 81C that partially overlap the upper parts of the vertical frames 13A, as viewed from the front. The bottom (rear-side) surface of each of the third front side bosses 81C is directed obliquely upward the rear, facing the corresponding upper part of the vertical frame 13A. When a predetermined load is applied to the front cover 8A from the front, the bottoms of the third front bosses 81C preferably come into contact with the corresponding vertical frames 13A. As a result, the load applied to the front cover 8A from the front is transmitted to the left and right vertical frames 13A. The front side bosses 81 also have a plurality of fourth front bosses 81D that partially overlap the upper part of the connecting member 10.

A rib 85 is provided in the center of the rear surface of the front cover front wall 71. The rib 85 may be formed in a lattice pattern. The rib 85 may extend so as to connect the front side bosses 81A, 81B, 81C, and 81D. The rib 85 improves the rigidity of the front cover 8A.

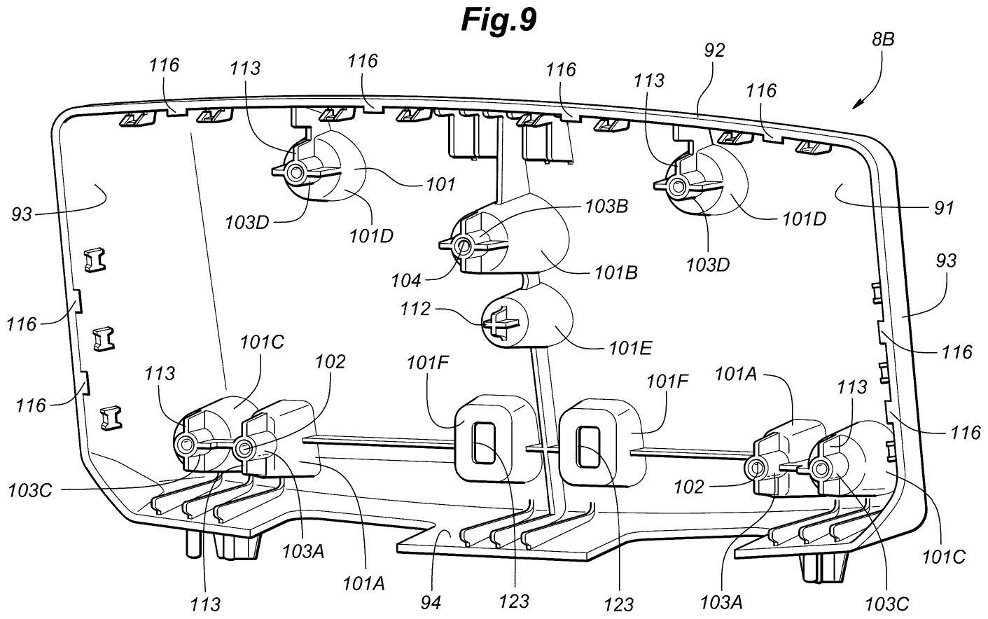

As shown in FIG. 9, the rear cover 8B has a box shape with an opening facing frontward. The rear cover 8B includes a rear cover rear wall 91 with front-facing and rear-facing surfaces, a rear cover upper wall 92 extending frontward from the upper edge of the rear cover rear wall 91, left and right rear cover side walls 93 extending frontward from the left and right side edges of the rear cover rear wall 91, and a rear cover lower wall 94 extending frontward from the lower edge of the rear cover rear wall 91.

The rear cover rear wall 91 has a plurality of rear side bosses 101 protruding frontward from the rear part of the rear cover rear wall 91. Each of the rear side bosses 101 may be formed as a bottomed hollow cylindrical or prismatic shape that opens rearward. In the present embodiment, the rear side bosses 101 comprises a plurality of first rear side bosses 101A that face the left and right first brackets 21, and a second rear side boss 101B that faces the second bracket 24. The first rear side bosses 101A face the corresponding first front side bosses 81A of the front cover 8A. The second rear boss 101B faces the second front boss 81B of the front cover 8A.

As also shown in FIG. 6, the rear cover 8B has a plurality of rear side first fastening holes 102 at positions aligned with the inner first through holes 22B of the first brackets 21 and the front side first fastening holes 83 of the first front side bosses 81A. Each of the rear side first fastening holes 102 is threaded to form a female screw. In the present embodiment, the rear side first fastening holes 102 are defined by the inner surfaces of corresponding first cylindrical portions 103A, which extend frontward from the front side bottom of the corresponding first rear side bosses 101A. The inner surface of each of the first cylindrical portions 103A is threaded to form a female screw.

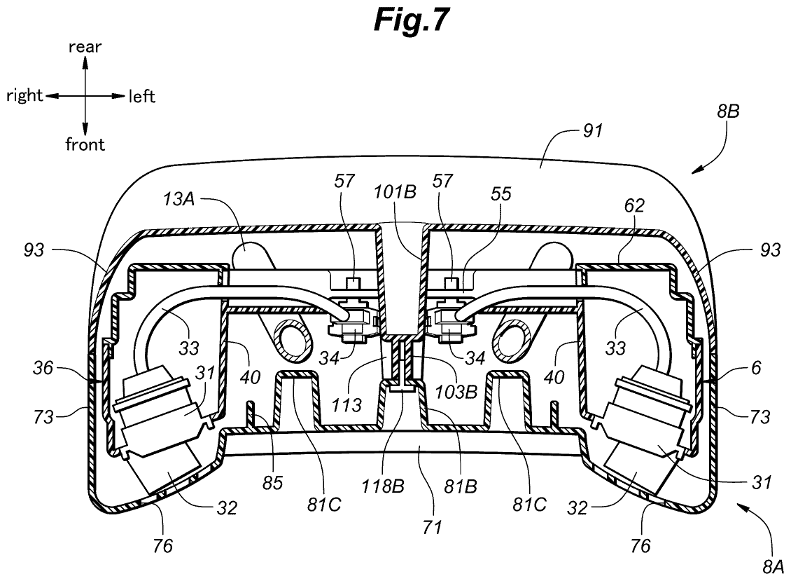

As shown in FIG. 7, the rear cover 8B has a rear side second fastening hole 104 at a position aligned with the second through hole 26 of the second bracket 24 and the front side second fastening hole 84 of the second front side boss 81B. The rear side second fastening hole 104 is threaded to form a female screw. In the present embodiment, the rear side second fastening hole 104 is defined by the inner surface of the second cylindrical portion 103B, which extends frontward from the bottom of the second rear side boss 101B. The inner surface of the second cylindrical portion 103B is threaded to form a female screw.

The rear side bosses 101 further include a plurality of third rear side bosses 101C that face the left and right first brackets 21. Specifically, the bottom of each of the third rear side bosses 101C faces the base of the corresponding first bracket 21 and the flap 43 on the lower wall 41 of the corresponding casing 36. Each of the third rear side bosses 101C has a third cylindrical portion 103C extending frontward from the bottom of the third rear side boss 101C. The center of each of the third cylindrical portions 103C is aligned with the center of the outer first through hole 22A of the corresponding first bracket 21 and the center of the through hole 44 of the corresponding flap 43. The inner surface of each of the third cylindrical portions 103C is threaded to form a female screw.

In addition, the rear side bosses 101 further include a plurality of rear side bosses 101D that face the fourth front side bosses 81D with the upper portion of the connecting member body 51 of the connecting member 10 being therebetween. Each of the bottom portions of the rear side bosses 101D has a fourth cylindrical portion 103D that extends frontward from the bottom of the rear side boss 101D. The connecting member body 51 of the connecting member 10 has a plurality of through holes 111 (FIG. 5) extending therethrough in the thickness direction at positions aligned with the fourth cylindrical portions 103D. The inner surface of each of the fourth cylindrical portions 103D may be threaded to form a female screw.

In addition, the rear side bosses 101 further include a fifth rear side boss 101E that faces the protruding tab 55 of the connecting member 10. The fifth rear side boss 101E has a positioning protrusion 112 which extends frontward from the bottom of the fifth rear side boss 101E and is engageable with the positioning hole 59.

Ribs 113 are formed on each of the outer peripheries of the cylindrical portions 103A, 103B, 103C, 103D of the rear side bosses 101A, 101B, 101C, 101D, and extend to the bottoms of the corresponding rear side bosses 101A, 101B, 101C, 101D. The ribs 113 extend radially outward from the left, right, top and bottom points along the circumference of each of the cylindrical portions 103A, 103B, 103C, 103D. The ribs 113 improve the rigidity of each of the cylindrical portions 103A, 103B, 103C, 103D and the positioning protrusion 112.

As shown in FIG. 8, the upper wall 72 and the left and right side walls 73 of the front cover have a plurality of flat plates 114 extending rearward from the whole or parts of rear edges of the walls 72, 73. The thickness of each flat plate 114 is smaller than that of the corresponding one of the walls 72, 73. Each flat plate 114 has 8 latching holes 115 extending therethrough in the thickness direction. As shown in FIG. 9, a plurality of latching pawls 116 are formed on the respective rear edges of the rear cover upper wall 92 and the left and right rear cover side walls 93, and the latching pawls 116 can be latched to the corresponding latching holes 115 formed in the front cover upper wall 72 and the left and right side walls 73 of the front cover. The front cover 8A and the rear cover 8B are joined together when the latching pawls 116 are latched in the corresponding latching holes 115.

As shown in FIG. 2, the front cover 8A and the rear cover 8B are fastened together by a plurality of first bolts 118A screwed into the rear side first fastening hole 102 and a second bolt 118B screwed into the rear side second fastening hole 104. Specifically, each of the first bolts 118A is passed through the front side first fastening hole 83 of the corresponding first front side boss 81A and the inner first through hole 22B of the corresponding first bracket 21 from the front, and is screwed into the female screw of the first cylindrical portion 103A of the corresponding first rear side boss 101A. As a result, the front cover 8A and rear cover 8B are fastened to the vertical frames 13A via the first bracket 21, which allows the headrest cover 8 to be stably supported by the headrest frame 5. The second bolt 118B is also passed through the second front side fastening hole 84 of the second front side boss 81B and the second through hole 26 of the second bracket 24, and is screwed into the female screw of the second cylindrical portion 103B of the second rear side boss 101B. As a result, the front cover 8A and rear cover 8B are attached to the horizontal frame 13B via the second bracket 24, which allows the headrest cover 8 to be more stably supported by the headrest frame 5.

As shown in FIG. 4, the left and right electrical components 6 are secured to the rear cover 8B by means of a plurality of third bolts 118C, which are screwed into the female screw of the third cylindrical portions 103C of the third rear side bosses 101C. Specifically, each of the third bolts 118C is passed rearward through the outer first through hole 22A of the corresponding first bracket 21 and the through hole 44 of the flap 43 of the corresponding casing 36, and is screwed into the female screw of the corresponding third cylindrical portion 103C. In addition, the left and right electrical components 6 are secured to the rear cover 8B by a plurality of fourth bolts 118D, which are screwed into the female screws of the fourth cylindrical portions 103D of the corresponding fourth rear side bosses 101D. Specifically, each of the fourth bolts 118D is passed rearward through the corresponding through hole 111 formed in the connecting member body 51 of the connecting member 10 and is screwed into the corresponding fourth cylindrical portion 103D. In this configuration, the left and right electrical components 6 and the rear cover 8B are supported by the left and right vertical frames 13A. This configuration, in which the left and right electrical components 6 are connected by the connecting member 10 and supported by the corresponding vertical frames 13A, determines the relative positions of the left and right electrical components 6.

Each of the plurality of fourth front side bosses 81D formed on the front cover 8A is positioned to overlap the corresponding fourth bolt 118D. When a predetermined load is applied to the front cover 8A from the front, the bottom of each of the fourth front side bosses 81D is in contact with the corresponding fourth bolt 118D. As a result, a load applied to the front cover 8A from the front is transmitted to the rear cover 8B via the fourth bolts 118D.

The left and right second harnesses 66 are secured to a plurality of harness catchers 121 provided on the rear cover 8B. Each of the harness catchers 121 is a plastic clip having a ring, through which the corresponding second harness 66 is passed. Each of the harness catchers 121 is latched to a corresponding one of latching holes 123 formed in the rear cover 8B by a latching pawl 122. As shown in FIG. 9, each latching hole 123 may be formed at the bottom of a corresponding one of sixth rear side bosses 101F that protrudes frontward from the rear surface of the rear cover rear wall 91. The latching holes 123 may extend through the bottom of the sixth rear side bosses 101F in the front-rear direction. The configuration, in which the second harnesses 66 are secured to the rear cover 8B by the harness catchers 121, prevents the movement of the second harnesses 66.

As shown in FIG. 3, the headrest 4 further has a plate-shaped headrest pad 131 that is covered by the headrest cover 8. Specifically, the headrest pad 131 includes a front side pad 131A and a rear side pad 131B provided over the front cover 8A and the rear cover 8B, respectively. The front side pad 131A and rear side pad 131B may be formed into separate components or integrally formed into one piece component. The headrest pad 131 may be formed from a foamed plastic material such as urethane. The front pad 131A is arranged to extend over the front cover front wall 71 and the front cover upper wall 72. More specifically, the front pad 131A is provided on the central parts of the front cover front wall 71 and the front cover upper wall 72, so as not to extend over the left and right second bulging parts 75.

As shown in FIG. 10, the headrest 4 further includes a skin 133, which covers a headrest pad 131 and a headrest cover 8. The skin 133 may be formed in a bag-like form with an opening at the bottom. The skin 133 includes at least one rear side hook (not shown) provided at the rear edge thereof, which is hooked to a corresponding front side hook (not shown) provided at the front edge thereof, thereby closing the opening of the skin 133.

The skin 133 includes a skin body 134 and air passage portions 135, which cooperate with each other to form an appearance of the headrest 4, and a sound absorbing layer 136 provided in the inner surface thereof. The skin body 134 may be formed into a sheet-like structure made of a flexible material such as plastics materials, natural leather, or synthetic leather. The skin body 134 has openings 137 which face the left and right second bulging parts 75.

The air passage portions 135 are coupled to the skin body 134 so as to block the openings 137 in the skin body 134. Each of the air passage portions 135 may, for example, have a seat layer 138 that cooperates with the skin body 134 to form an appearance of the headrest 4, and a mesh layer 139 provided on the back surface of the seat layer 138. The mesh layer 139 may be bonded to the inner surface of the seat layer 138 using an adhesive or any other bonding means. The seat layer 138 may be formed of the same material as the skin body 134. The seat layer 138 has a plurality of through holes 141 (FIG. 1) extending in the thickness direction.

Each of the air passage portions 135 may be joined to the skin body 134 e.g., by sewing with a sewing thread 142 to join the periphery of each of the air passage portions 135 to the edge of the corresponding opening 137 in the skin body 134.

The sound absorbing layer 136 is provided on the inner surface of the skin body 134 facing the rear cover rear wall 91 of the rear cover 8B. In other words, the sound absorbing layer 136 reduces sound leakage in the rear direction. The sound absorbing layer 136 may be a vibration-proof material, such as a rubber sheet or felt. Alternatively, the sound absorbing layer 136 may be, for example, polyurethane foam. The sound absorbing layer 136 may be bonded to the skin body 134 e.g., using an adhesive.

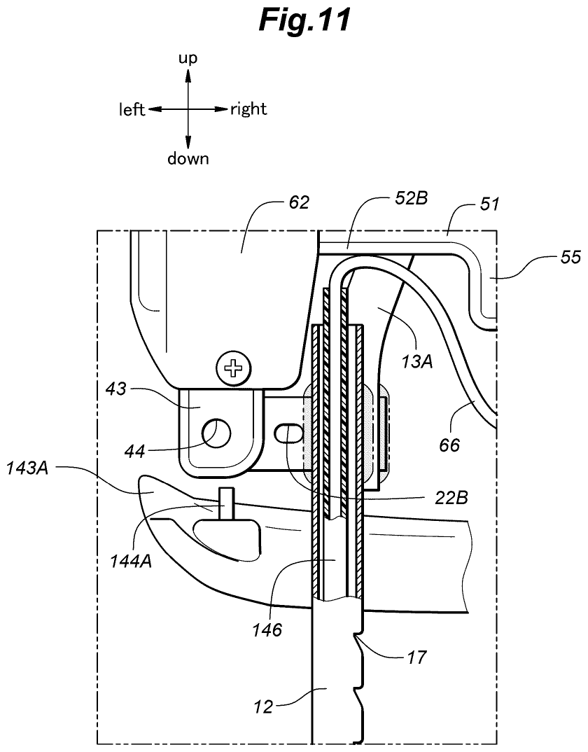

As shown in FIG. 3, the headrest 4 may further include a plurality of lower covers 143 for covering and hiding the opening of the closed skin 133. The lower covers 143 may include a front lower cover 143A attached to the front cover 8A and a rear lower cover 143B attached to the rear cover 8B. The front lower cover 143A extends in the left-right direction and has a plate shape with up-facing and down-facing surfaces. The front lower cover 143A may be attached to the front cover lower wall 74 by, for example, a plurality of engaging protrusions 144A (FIG. 11) provided on the front lower cover 143A inserted into corresponding latching holes (not shown) provided on the front cover lower wall 74. The rear lower cover 143B extends in the left-right direction along the rear cover lower wall 94 and is formed as a plate with a surface facing in the up-down direction. The rear lower cover 143B may be attached to the rear cover lower wall 94 in the same manner as the front lower cover 143A, for example, by a plurality of engaging protrusions (not shown) provided on the rear lower cover 143B inserted into the corresponding latching holes (not shown) provided on the rear cover lower wall 94. The lower cover 143 may be formed of the same material as the headrest cover 8, for example.

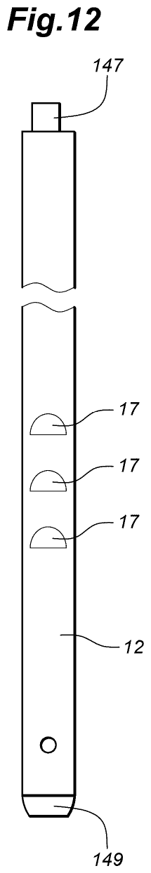

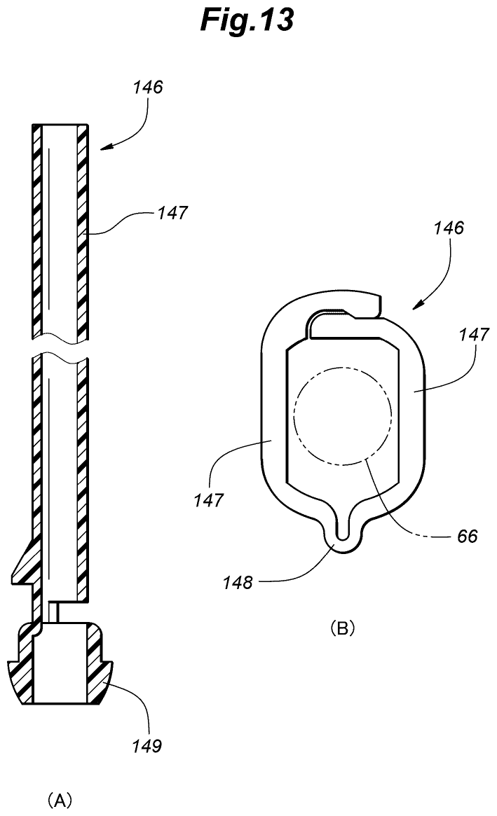

As shown in FIGS. 11 to 13, each of the second harnesses 66 is provided with a protection member 146 that surrounds the second harness 66. Each of the protection members 146 extends in the vertical direction and is inserted inside the corresponding headrest stay 12. The protection member 146 may comprise a pair of protection member bodies 147 each having a U-shaped shape in cross-section, and an integral hinge 148 connecting the left or right ends of the protection member bodies 147 FIG. 13(B)). The other ends of the protection member bodies 147 may be engaged with each other by means of a snap fit. In addition, a grommet 149 may be provided at the lower end of each of the protection member bodies 147, which is attached to the lower edge defining the lower end opening of the headrest stay 12 (FIG. 13 (A)). The vertical length of each of the protection members 146 is longer than that of the headrest stays 12. The protection member 146 and the grommet 149 may be formed of a plastics material.

Each of the grommets 149 prevents contact between the lower edge of the corresponding headrest stay 12 and the corresponding second harness 66. In addition, when each of the grommets 149 is attached to the lower edge of the corresponding headrest stay 12, the upper edge of the corresponding protection member body 147 extends upward from the upper end opening of the headrest stay 12. This feature prevents contact between the upper edge, which defines the upper end opening of the headrest stay 12, and the corresponding second harness 66.

Next, a method of manufacturing the headrest 4 of the present embodiment will be described. First, the vertical frames 13A corresponding to the left and right headrest stays 12 are welded together. Next, each of the first brackets 21 is welded to the corresponding vertical frame 13A. Next, the second bracket 24 is welded to the horizontal frame 13B.

Next, the second harnesses 66 are inserted into the inner spaces of the corresponding headrest stays 12. In this step, the upper ends of the second harnesses 66 do not need to be connected to the corresponding male connectors 64. The second harnesses 66 with the protection members 146 attached thereto are inserted into the inner spaces of the corresponding headrest stays 12 from the lower ends toward the upper ends thereof. As a result, even when each of the second harnesses 66 is branched, the protection member 146 allows the second harnesses 66 to be bundled together, facilitating the insertion of the second harnesses 66 into the inner spaces of the headrest stays 12. Then, the grommet 149 is attached to the lower edge of each of the headrest stays 12. Next, the male connector 64 is connected to the upper end of each second harness 66. After the lower end of each of the second harnesses 66 is passed through the stay support 16, a connector (not shown) for connecting to the control device 68, is attached to the lower end of the second harness 66.

Next, the speaker units 31 and the microphone units 32 are housed in the corresponding casings 36. Specifically, first, the left and right casings 36 and the connecting member 10 are prepared. The left and right casings 36 and connecting member 10 may be components formed e.g., by injection molding. Then, the speaker units 31 and the microphone units 32 are placed in the corresponding casings 36. Next, the inner end of each of the first harnesses 33 is pulled from the rear to the front through the tab hole 56 of the connecting member 10. Then, the female connectors 34 are connected to the inner ends of the corresponding first harnesses 33. Then, the female connectors 34 are secured to the front of the protruding tab 55 of the connecting member 10. Next, the lid 62 is attached to the rear of each of the left and right casings 36 using a fastener such as a bolt.

Next, the electrical components 6 are attached to the rear cover 8B. Specifically, first, the positioning protrusion 112 provided on the rear cover 8B is inserted into the positioning hole 59 on the protruding tab 55 of the connecting member 10. This step determines the positions, to which the electrical components 6 are attached, relative to the rear cover 8B. Then, the fourth bolts 118D are passed through the corresponding through holes 111 formed in the connecting member body 51 of the connecting member 10 from the front and are screwed into the fourth cylindrical portions 103D of the fourth rear side bosses 101D. This step allows the electrical components 6 to be fastened to the rear cover 8B.

Next, the electrical components 6 and the rear cover 8B are attached to the headrest frame 5. Specifically, the third bolts 118C are passed through the outer first through holes 22A of the corresponding first brackets 21 and the through hole 44 of the flaps 43 of the corresponding casings 36 from the front, and then are screwed into the third cylindrical portions 103C of the third rear side bosses 101C. This step allows the casings 36 to be fastened to the rear cover 8B. The configuration, in which the female connectors 34 of the first harnesses 33 are secured to the protruding tab 55 of the connecting member 10, prevents interference between the female connectors 34 and other components when the electrical components 6 are attached to the headrest frame 5, thereby facilitating the assembly of the electrical components 6 to the headrest frame 5.

Next, the male connectors 64 connected to the upper ends of the second harnesses 66 are fitted into the female connectors 34 connected to the inner ends of the corresponding first harnesses 33. Then, the second harnesses 66 are secured to the rear cover 8B by the corresponding harness catchers 121.

Next, the front cover 8A is attached to the rear cover 8B. the latching pawls 116 are engaged with the corresponding latching holes 115, where the latching pawls 116 are provided on the rear edges of the rear cover upper wall 92 and the rear edges of the left and right rear cover side walls 93, and the latching holes 115 are formed in the front cover upper wall 72 and the left and right front cover side walls 73.

Next, the first bolts 118A are passed through the front side first fastening holes 83 of the corresponding first front side bosses 81A and the inner first through holes 22B of the corresponding first brackets 21 from the front, and are screwed into the first cylindrical portions 103A of the first rear side bosses 101A. Then, the second bolt 118B is passed through the front side second fastening hole 84 of the second front side boss 81B and the second through holes 26 of the corresponding second brackets 24 from the front, and are screwed into the second cylindrical portion 103B of the second rear side boss 101B.

Next, the headrest pad 131 is attached to the headrest cover 8. Then, the skin 133 is placed over the headrest pad 131 and the headrest cover 8. Then, the opening of skin 133 is closed by the rear side hooks provided at the rear edge of skin 133 hooked onto the corresponding front side hooks provided at the front edge of skin 133. Next, the front lower cover 143A is attached to the front cover lower wall 74, and the rear lower cover 143B is attached to the lower wall 41 of the rear cover 8B. In this way, the headrest 4 is assembled.

In the headrest 4 of the present embodiment, the left and right electrical components 6 are arranged on the left and right sides of the vertical frames 13A, and the connecting member 10 is arranged rearward of the horizontal frame 13B, so the load from the front is applied to the horizontal frame 13B. This configuration prevents a load from being applied to the electrical components 6 and the connecting member 10 from the front, thereby reducing the deformation of the electrical components 6 and the connecting member 10. In other words, this configuration reduces a change in the relative positions of the left and right electrical components 6. The electrical components 6 are covered by the headrest cover 8, a load applied to the headrest 4 is transmitted to the headrest cover 8, which further reduces the deformation of the electrical components 6 and the deformation of the connecting member 10.

Specific embodiments of the present invention are described above. However, those embodiments are non-limiting, and various modifications may be made to the embodiments without departing from the scope of the present invention. For example, although the electrical components 6 are provided at locations laterally outer than the vertical frames 13A, the electrical components 6 may be provided at locations laterally inner than the vertical frames 13A. Although, in the above embodiments, the inner surfaces of the first cylindrical portion 103A and the second cylindrical portion 103B are formed with female screws, in the first cylindrical portion 103A and the second cylindrical portion 103B may be formed without female screws. In the latter case, the bottoms of the first rear side boss 101A and the second rear side boss 101B preferably have through holes extending therethrough in the thickness direction and formed to be aligned with the corresponding first and second cylindrical portions 103A and 103B. Each bolt is preferably passed through the through hole of the corresponding one of the rear bosses 101A and 101B, and fastened by a nut.

### GLOSSARY

1 seat (vehicle seat)
3 seat back
4 headrest
5 headrest frame
6 electrical components
8 headrest cover
8A front cover
8B rear cover
10 connecting member
12 headrest stay
13A vertical frame
13B horizontal frame
21 first bracket
22B inner first through hole (first through hole)
24 second bracket
26 second through hole
31 speaker unit
33 first harness
34 female connector
51 connecting member body
52A upper first reinforcing part (first reinforcing part)
53 second reinforcing part
55 protruding tab
56 tab hole
59 positioning hole
64 male connector
66 second harness
81C third front boss (front cover protrusion)
83 front side first fastening hole
84 front side second fastening hole
102 rear side first fastening hole
104 rear side second fastening hole
112 positioning protrusion
118A first bolt
118B second bolt
121 harness catcher

1. A headrest for a vehicle seat, the headrest comprising:
a headrest frame supported by a seat back;
a pair of left and right electrical components supported by the headrest frame; and
a connecting member extending in a left-right direction and configured to connect the left and right electrical components,
wherein the headrest frame comprises:
a pair of left and right headrest stays that are supported by the seat back, and extend in a vertical direction,
a pair of left and right vertical frames that extend in the vertical direction and are attached to the corresponding headrest stays, and
a horizontal frame that extends in a left-right direction and connects upper ends of the vertical frames,
wherein upper parts of the vertical frames extend obliquely upward toward the front,
wherein the electrical components are arranged outside of the vertical frames in the left-right direction,
wherein lower parts of the electrical components are supported by lower part of the vertical frames, and
wherein the connecting member is located rearward of the horizontal frame.

2. The headrest as claimed in claim 1, wherein the vertical frames are provided with first brackets that extend outward in the left-right direction, and
wherein the electrical components are secured to the corresponding first brackets.

3. The headrest as claimed in claim 2, wherein the connecting member comprises:
a connecting member body with a front-facing surface and a rear-facing surface,
a first reinforcing part that extends rearward from the upper end of the connecting member body, and
a plurality of second reinforcing parts that protrude rearward from the rear-facing surface of the connecting member body and are connected to the first reinforcing part.

4. The headrest as claimed in claim 3, wherein the connecting member further comprises a protruding tab that protrudes downward from the connecting member body and a tab hole formed above the protruding tab,
wherein each of the electrical components includes a speaker unit, a first harness with a first end connected to the speaker unit, and a female connector connected to a second end of the first harness,
wherein the first end of the first harness is located rearward of the connecting member body of the connecting member, and
wherein the female connector is secured to a front surface of the protruding tab.

5. The headrest as claimed in claim 4, wherein each of the electrical components includes a male connector fitted into the female connector, and a second harness connected to the male harness,
wherein each of the headrest stays has a tubular shape,
wherein a front part of the upper end of each of the headrest stays is coupled to a rear part of the lower end of the corresponding vertical frame, and
wherein each of the second harnesses extends through a hole inside the corresponding headrest stay.

6. The headrest as claimed in claim 5, further comprising a headrest cover that covers the electrical components, the vertical frames, and the horizontal frame,
wherein the headrest cover includes a front cover that covers the electrical components, the vertical frames and the horizontal frame from the front, and a rear cover that engages the front cover and covers the electrical components, the vertical frames and the horizontal frame from the rear, and
wherein the second harnesses are secured to harness catchers provided on the rear cover.

7. The headrest as claimed in claim 6, wherein the left and right first brackets each have at least one first through hole formed therein,
wherein the front cover has front side first fastening holes that are aligned to the first through holes,
wherein the rear cover has rear side first fastening holes that are aligned to the first through holes and the front side first fastening holes,
wherein each of the rear side first fastening holes is threaded to form a female screw, and
wherein the front cover and the rear cover are fastened with first bolts that extend through the first through holes and the front side first fastening holes, and are screwed to the female screws formed in the rear side first fastening holes.

8. The headrest as claimed in claim 7, wherein the horizontal frame includes a second bracket provided at a location that is aligned to the tab hole,
wherein the second bracket has a second through hole formed therein,
wherein the front cover has a front side second fastening hole that is aligned to the second through hole,
wherein the rear cover has a rear side second fastening hole that is aligned to the second through hole and the front side second fastening hole,
wherein the rear side second fastening hole is threaded to form a female screw, and
wherein the front cover and the rear cover are fastened with a second bolt that extends through the second through hole and the front side second fastening hole and that is screwed to the female screw formed in the rear side second fastening holes.

9. The headrest as claimed in claim 8, wherein the front cover has front cover protrusions that protrude rearward from the front cover and that overlap the headrest frame as viewed from the front.

10. The headrest as claimed in claim 9, wherein the protruding tab of the connecting member body has a positioning hole extending therethrough in the front-rear direction, and
wherein the rear cover has a positioning protrusion that engages the positioning hole.
